(19) United States
(12) Patent Application Publication
(10) Pub. No.: US 2023/0039345 A1
(43) Pub. Date: Feb. 9, 2023

(54) APPARATUS WITH MULTIPURPOSE PRESSURE SENSITIVE MATERIAL AND METHOD OF LEAK IDENTIFICATION

(71) Applicants: NATIONAL CHENG KUNG UNIVERSITY, Tainan City (TW); National Sun Yat-sen University, Kaohsiung City (TW)

(72) Inventors: Ming-Yeng LIN, Tainan City (TW); Jr-Jeng RUAN, Tainan City (TW); Huann-Shyang LIN, Kaohsiung City (TW); Yi-Hsueh CHEN, Tainan City (TW)

(21) Appl. No.: 17/971,988

(22) Filed: Oct. 24, 2022

Related U.S. Application Data
(63) Continuation-in-part of application No. 17/227,415, filed on Apr. 12, 2021.
(60) Provisional application No. 63/271,234, filed on Oct. 25, 2021.

(51) Int. Cl. A62B 23/02; A62B 18/02; A41D 13/11

(52) U.S. Cl. CPC A62B 23/025; A62B 18/02; A41D 13/1107

(57) ABSTRACT

An apparatus with multipurpose pressure sensitive materials, includes an outer part and a pressure sensitive material. The sensitive material is configured to change colors according to contact state between the outer part with an object and/or according to the outer part itself.

### CROSS REFERENCE TO RELATED APPLICATION

This application claims the benefit of filing date of U.S. Provisional Application Ser. No. 63/271,234, entitled “AN APPARATUS WITH MULTIPURPOSE PRESSURE SENSITIVE MATERIALS AND METHOD THEREFOR” filed Oct. 25, 2021 under 35 USC § 119(e)(1).

This application is a continuation-in-part (CIP) of U.S. Patent application for “APPARATUS FOR IDENTIFYING LEAK OF FACE MASK AND METHOD THEREFOR”, U.S. application Ser. No. 17/227,415 filed Apr. 12, 2021, and the subject matter of which is incorporated herein by reference.

### BACKGROUND OF THE INVENTION

### 1 Field of the Invention

The present invention relates to an apparatus for identifying the pressure of an object using a pressure sensitive material and a method therefor, and in particular, the pressure sensitive material of the present invention is applicable but not limited to a mask, earmuffs, a container, pressure sensitive paint, seating crow, bridge or denture.

### 2. Description of Related Art

Pressure identification and its applications are important in many fields. An existing pressure identification method, for example the use of a pressure sensitive film (such as Fujifilm Prescale Film), can change color once pressure is added upon. However, the color changing process is irreversible, and thus cannot be used to monitor and indicate constantly changing pressure (for example, from high pressure to low pressure and then from low pressure back to high pressure).

Another existing approach relates to the use of a pressure sensor. However, the pressure sensor has to be connected to an electronic device, which suggests that it is not readily applicable to daily necessities with small size, and the pressure sensor is costly. In addition, the pressure sensor often requires a monitor to output the values, so the availability is limited.

Therefore, developing a pressure sensitive material that is capable of changing color under different pressures is needed. The material can also be used for other purposes such as leak identification, wherein when the pressure added upon is less means a leak occurs.

Leak identification is important for the face masks, the earmuffs, and the containers. When the face mask has a leak, the user is not well protected. Face mask includes tight-fitting face mask and loose-fitting face mask. Respirators usually refer to “tight-fitting” face masks, such as a filtering facepiece respirator (such as N95 respirator), a Powered Air-Purifying Respirator (PAPR), a Supplied-Air Respirator (SR) or a Self-Contained Breathing Apparatus (SCBA). Respirator can help protect the users exposed in the hazardous environment (or generally, air-polluted environment). Loose-fitting face mask includes a surgical mask, a dust mask, and a cloth face covering. Loose-fitting face masks are more comfortable to wear, but provide less protection to the workers.

Both tight-fitting face mask and loose-fitting face mask are capable of protecting the users to some extent. For different environments, users can choose different kinds of face masks. Note that in a hazardous environment even a little leak can pose danger to the user. Thus, identifying the face mask leak location and fixing the leak is important and can help protect the user wearing the face mask.

People who wear respirators perform a seal check (fit check) to determine if the respirator is properly fit. However, the accuracy of the seal check is questionable according to a research on Journal of Hospital Infection by J. L. Derrick et al (Derrick J L, Chan Y F, Gomersall C D, Lai S F. Predictive value of the user seal check in determining half-face respirator fit. J Hosp. Infect. 2005; 59, 152-155). In addition, the face mask users have to perform a fit check (or fit text) every time they put the face mask on. This process is time consuming and cannot immediately identify the location of the leak. Finally, the fit test requires instruments, which suggests it may not be reachable to all users.

In US Pat. No. 2016/0166859 A1, Rachapudi et al disclosed a more accurate method. The method used a pressure sensor and a computing device to quantify the leak. Although this may be a more accurate method, the additional electronic device may not be economically feasible to those with a tight budget. In addition, this method cannot find the location of the leak. In CN 1919376 B, Zhu disclosed a kind of low-cost leak detection device which is capable of locating the leak location. This device does not need a pressure sensor, but it requires a transparent material for one side and requires fine frosted texture for the other side. However, this leak detection device cannot be applied to the commercial N95 respirators or surgical masks.

### SUMMARY OF THE INVENTION

An apparatus with multipurpose pressure sensitive materials and method therefor includes an outer part and pressure sensitive materials that can detect the pressure and/or leaking location of the outer part. The outer part here can be, but not limited to a face mask, ear muff or a container, a denture, or a force. The pressure sensitive materials can change to different colors under different pressure at a desired time. The pressure sensitive materials can also change back to its' original colors once the pressure is removed. Thus, the pressure sensitive materials are a reusable material.

When a user properly wears a face mask, there is a pressure between the user's face and face mask or the face seal of the face mask. When a user properly wears an ear muff, there is a pressure between the user's head and ear muff. When using an airtight container, the lid of the container has rubber seal that generates pressure on the container to seal the container. If the pressure in the above scenarios is too low at a specific location, it indicates that there is a leak at that location. In addition, the dentist can put the pressure sensitive material on the denture to help identify and adjust the pressure distribution of the patient when wearing the denture. Finally, the pressure sensitive material can be within pressure sensitive paint to help identify the pressure distribution with the outer force.

In view of the forgoing, according to one aspect, the present invention provides an apparatus with multipurpose pressure sensitive materials. The apparatus with multipurpose pressure sensitive materials includes an outer part and a pressure sensitive material. The sensitive material is configured to come to change according to contact state between the outer part with an object and/or according to the outer part itself.

Optionally, or preferably, in the apparatus with multipurpose pressure sensitive materials of the present invention, the pressure sensitive material is a polymer matrix composite or other material, the pressure sensitive material can change colors with different added pressure.

Optionally, or preferably, in the apparatus with multipurpose pressure sensitive materials of the present invention, the color change of the pressure sensitive material is a reversible reaction.

Optionally, or preferably, in the apparatus with multipurpose pressure sensitive materials of the present invention, the pressure sensitive material is configured to indicate if a leak occurs through the color change according the contact state and/or the outer part itself (i.e. if a leak occurs, the contact pressure is generally lower which can be shown by the pressure sensitive material).

Optionally, or preferably, in the apparatus with multipurpose pressure sensitive materials of the present invention, the outer part is a loose-fitting face mask, the loose-fitting face mask comprising a cloth face mask, a dust face mask, or a surgical mask.

Optionally, or preferably, in the apparatus with multipurpose pressure sensitive materials of the present invention, the outer part is a tight-fitting mask, the tight-fitting face mask comprising a N95, N99, N100, P95, P99, P100, R95, R99, R100 respirator, an Air-purifying Respirator, a Powered Air-Purifying Respirator (PAPR), a Supplied-Air Respirator (SR) or a Self-Contained Breathing Apparatus (SCBA).

Optionally, or preferably, in the apparatus with multipurpose pressure sensitive materials of the present invention, the pressure sensitive material is a polymer matrix composite, the polymer matrix composite contains nanoparticles.

Optionally, or preferably, in the apparatus with multipurpose pressure sensitive materials of the present invention, the loose-fitting face mask has an inner side and an outer side, the inner side is suitable for contacting a user's face, the outer side is opposite to the inner side, and wherein the pressure sensitive material is disposed on the inner side of the loose-fitting face mask.

Optionally, or preferably, in the apparatus with multipurpose pressure sensitive materials of the present invention, the tight-fitting face mask has an inner side and an outer side, the inner side is suitable for contacting a user's face, the outer side is opposite to the inner side, and wherein the pressure sensitive material is disposed on the inner side of the tight-fitting face mask.

Optionally, or preferably, in the apparatus with multipurpose pressure sensitive materials of the present invention, the outer part is earmuffs.

Optionally, or preferably, in the apparatus with multipurpose pressure sensitive materials of the present invention, the outer part is attached to an inner side of the earmuffs to contact a user's head.

Optionally, or preferably, in the apparatus with multipurpose pressure sensitive materials of the present invention, the outer part is a container.

Optionally, or preferably, in the apparatus with multipurpose pressure sensitive materials of the present invention, the pressure sensitive material is attached to a battle mouth of the container or an inner side of a lid thereof.

Optionally, or preferably, in the apparatus with multipurpose pressure sensitive materials of the present invention, the outer part is a crown, a bridge or a partial denture, and wherein the pressure sensitive material is a pressure indicating paste, coated on an inner side of the crown, the bridge or the partial denture.

Optionally, or preferably, in the apparatus with multipurpose pressure sensitive materials of the present invention, the pressure sensitive material is further configured to change color with an outer force, and configured to change back to it's original color when the outer force disappears.

Optionally, or preferably, in the apparatus with multipurpose pressure sensitive materials of the present invention, the pressure sensitive material is further configured to change color with an adjustable time under pressure, and the color change due to pressure can be quick or slow.

Optionally, or preferably, in the apparatus with multipurpose pressure sensitive materials of the present invention, the pressure sensitive material is made into a pressure sensitive paint that can be used in an aerodynamic field.

According to another aspect, the present invention provides a method of leak identification. The method is executed by an apparatus with multipurpose pressure sensitive materials including an outer part and a pressure sensitive material. The sensitive material is configured to come to change according to contact state between the outer part with an object and/or according to the outer part itself. The method comprises:

step S1: attaching the pressure sensitive material to the outer part;

step S2: using the outer part to contact the object;

step S3: observing if a color change of the pressure sensitive material occurs; and

step S4: determining a leak location according to a location of the color change.

Optionally, or preferably, in the method of leak identification of the present invention, determining a leak location according to a location of the color change is performed by scanning the object through an image detecting device or by eyes.

Optionally, or preferably, in the method of leak identification of the present invention, the outer part is a face mask, an earmuff, a container.

### BRIEF DESCRIPTION OF THE DRAWINGS

FIGS. 1A-1D show schematic views of the apparatus with multipurpose pressure sensitive materials according to the first embodiment of the present invention;

FIG. 2A shows a schematic diagram of the multilayer structure in the apparatus with multipurpose pressure sensitive materials according to the second embodiment of the present invention;

FIGS. 2B-2C show schematic views of the apparatus with multipurpose pressure sensitive materials according to the second embodiment of the present invention;

FIGS. 3A-3C show schematic views of the apparatus with multipurpose pressure sensitive materials according to the third embodiment of the present invention;

FIGS. 4A-4C show schematic views of the apparatus with multipurpose pressure sensitive materials according to the fourth embodiment of the present invention;

FIGS. 5A-5C show schematic views of the apparatus with multipurpose pressure sensitive materials according to the fifth embodiment of the present invention; and

FIG. 6 shows a flowchart of the method of leak identification according to an embodiment of the present invention.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, the terms, such as “preferably” or “advantageously”, are used to describe an optional or additional element or feature, and in other words, the element or the feature is not an essential element, and may be ignored in some embodiments.

Moreover, in the present specification, when an element is described to be “suitable for” or “adapted to” another element, the other element is an example or a reference helpful in imagination of properties or applications of the element, and the other element is not to be considered to form a part of a claimed subject matter; similarly, except otherwise specified; similarly, in the present specification, when an element is described to be “suitable for” or “adapted to” a configuration or an action, the description is made to focus on properties or applications of the element, and it does not essentially mean that the configuration has been set or the action has been performed, except otherwise specified.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

### General Embodiment

(Apparatus)

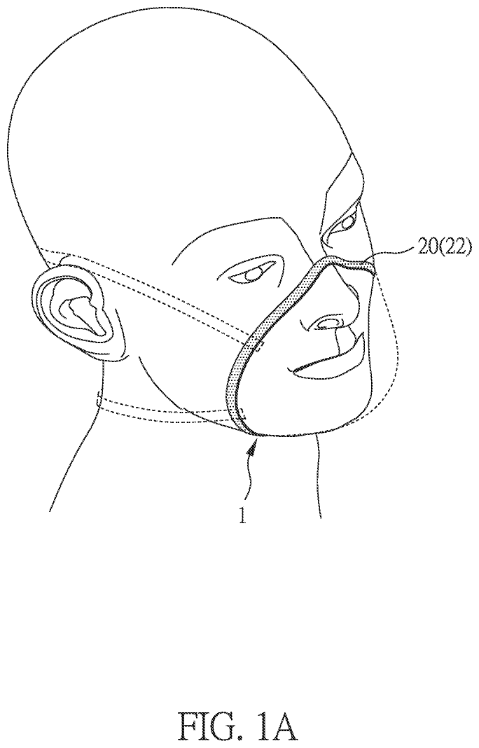

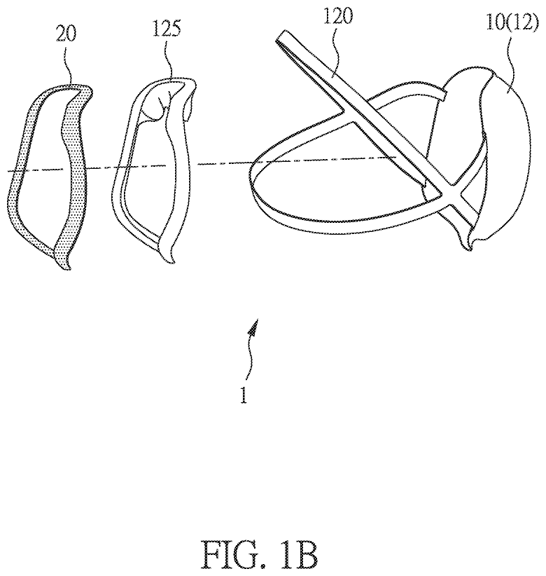

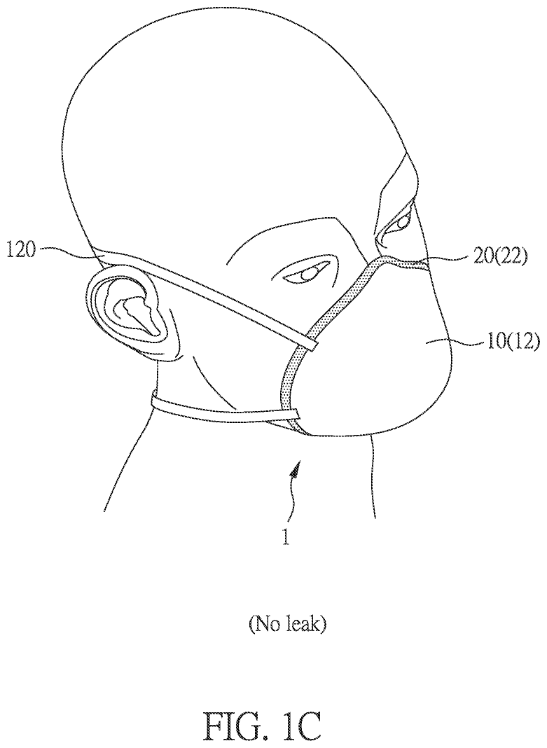

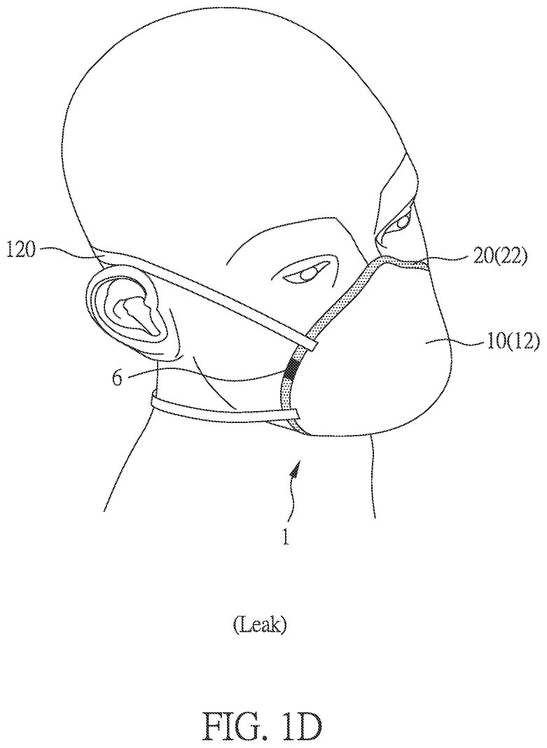

In one general embodiment, the apparatus 1 with multipurpose pressure sensitive materials includes an outer part 10 and a pressure sensitive material 20 (with reference to FIG. 1A to FIG. 4C). The pressure sensitive material 20 is configured to come to change (in particular, visually change) according to a contact state between the outer part 10 and an object and/or according to the outer part 10 itself.

In more specific embodiments, the outer part 10 may be a face mask 12, earmuffs 14 or a container 15, the details of which will be illustrated in FIG. 1A to FIG. 4C.

In particular, the pressure sensitive material 20 of the present invention can be simply attached to an outer rim of the outer part to realize their engagement to achieve an outstanding effect on leak detection. More particularly, the apparatus 1 with multipurpose pressure sensitive materials can achieve the objective of effectively identifying the leak location.

(Material)

The pressure sensitive material 20 can be a polymer matrix composite or other material. The pressure sensitive material 20 being configured to come to change includes changing with the pressure added (or applied) thereon. Thus, a user can identify the leak location through the color change. It is quite convenient. In addition, the color change of the pressure sensitive material 20 is reversible, and thus the pressure sensitive material 20 can be reusable. The reusable feature of the pressure sensitive material can be more environmental friendly.

(Method)

According to the above-mentioned apparatus 1 with multipurpose pressure sensitive materials, the present invention also provides a method of leak identification.

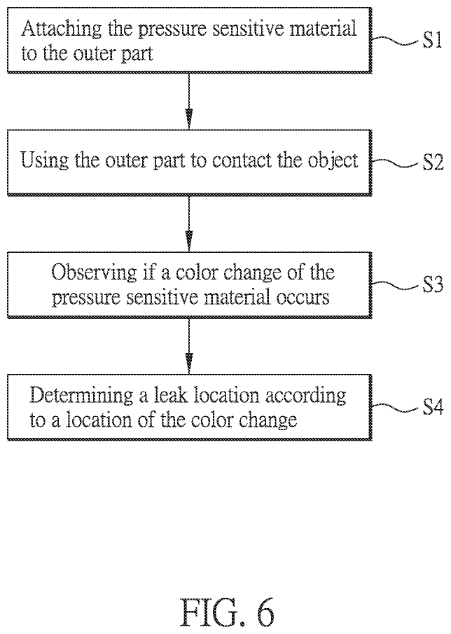

FIG. 6 shows a flowchart of the method of leak identification according to an embodiment of the present invention. With reference to FIG. 6, the method includes:

step S1: attaching the pressure sensitive material 20 to the outer part 10;

step S2: using the outer part 10 to contact the object;

step S3: observing if a color change of the pressure sensitive material 20 occurs; and

step S4: determining a leak location according to a location of the color change.

In some embodiments, the determination in the step S3 can be performed by a user's eyes to identify the leak, while in other embodiments, the determination in the step S3 can be performed by scanning a user's face through an imaging detecting device or by taking a picture of a user's face through a camera.

In the present invention, the image detecting device can be disposed at an entrance of an operating room, premises, or any kinds of rooms. When the wearers walk into the door, the image detecting device can immediately detect and determine whether the face mask leaks or not, so as to ensure that operations, experiments, or any other works are proceeding safely.

### First Embodiment

FIGS. 1A-1D show schematic views of the apparatus 1 with multipurpose pressure sensitive materials according to the first embodiment of the present invention.

With reference to FIG. 1A, in the first embodiment, the apparatus 1 with multipurpose pressure sensitive materials includes an outer part 10 and a pressure sensitive material 20. In particular, in the first embodiment, the outer part is a face mask 12, wherein the face mask 12 may be a tight-fitting face mask. The tight-fitting face mask may be a N95, N99, N100, P95, P99, P100, R95, R99, R100 respirator, an Air-purifying Respirator, a Powered Air-Purifying Respirator (PAPR), a Supplied-Air Respirator (SR) or a Self-Contained Breathing Apparatus (SCBA).

In FIG. 1A, taken as an example, the outer part 10 (i.e., the face mask 12 in the present embodiment) is illustrated as an N95 face mask 12.

Of course, in other embodiments, the face mask 12 may be a loose-fitting face mask, including a cloth face covering, a dust face mask or a surgical mask.

In the first embodiment, the N95 face mask 12 has an inner side an outer side. The inner side is suitable for a contact with a user's face, and the outer side is opposite to the inner side. The pressure sensitive material 20 is disposed on the inner side of the loose-fitting face mask or the tight-fitting face mask. The example herein can be applied to other types of face mask including respirators.

Furthermore, the N95 face mask 12 can be wrapped by a soft seal 125 as shown in FIG. 1B. The soft seal 125 can be made of silica gel, so it can make the experience of wearing N95 face mask 12 more comfortable. In the case of the N95 face mask with the soft seal 125, the pressure sensitive material 20 may be applied to the soft seal 122, so as to check if the soft seal 125 fits the user's face and if there is a leak. When a leak occur the contact pressure of the soft seal and user's face is lower, the change of the pressure can be seen in the soft seal's pressure sensitive material.

When the N95 face mask 12 is properly used, the color of the pressure sensitive material 20 can change to a certain color (gray, for example), which indicates that the pressure added on the pressure sensitive material 20 is the same everywhere, as shown in FIG. 1C. The user can confirm that the mask 12 has no leak after the user sees the color of the pressure sensitive material 20 has been changed everywhere.

However, when the pressure applied to the N95 face mask 12 is insufficient at the engagement with the user's face indicates that a leak occurs. At the moment, the pressure sensitive material 20 may not change color (remain black, for example) at the leak location 6. In this way, the user can see the leak location where the color is unchanged, as shown in FIG. 1D. The color change may be realized by full color or grayscale to show the leak level.

Thus, through the apparatus 1 with multipurpose pressure sensitive material, a convenient method of leak identification is proposed. The method includes the following steps:

step S1: attaching the pressure sensitive material 20 to the outer part 10;

step S2: using the outer part 10 to contact the object;

step S3: observing if a color change of the pressure sensitive material 20 occurs; and

step S4: determining a leak location according to a location of the color change.

Accordingly, based on the method above, it is easy to understand the leak location through the color change. The leak can be prevented by simply pressing the cross-bar of the face mask, or adjusting the straps 120.

Therefore, the objective of the protection for respiratory system is achieved.

### Second Embodiment

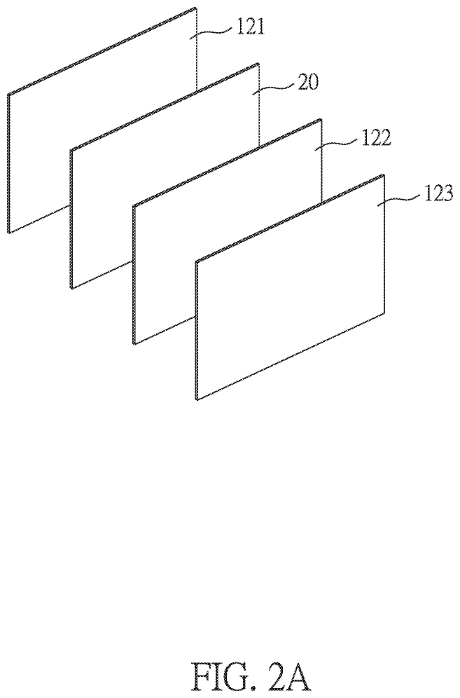

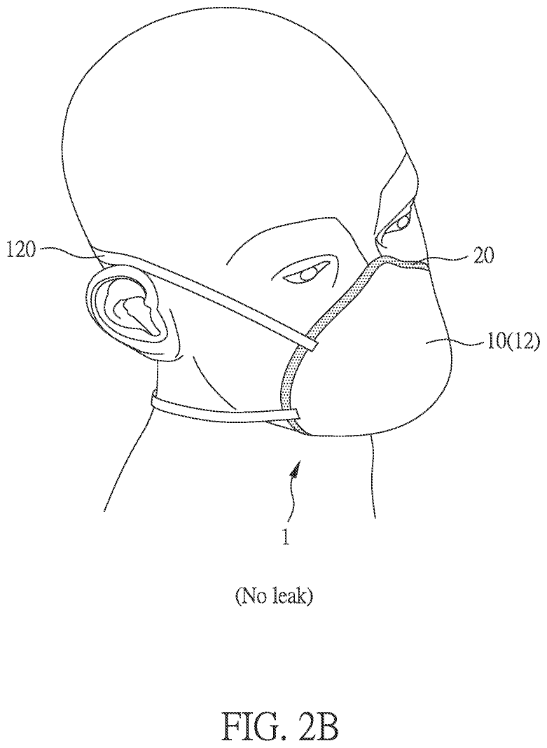

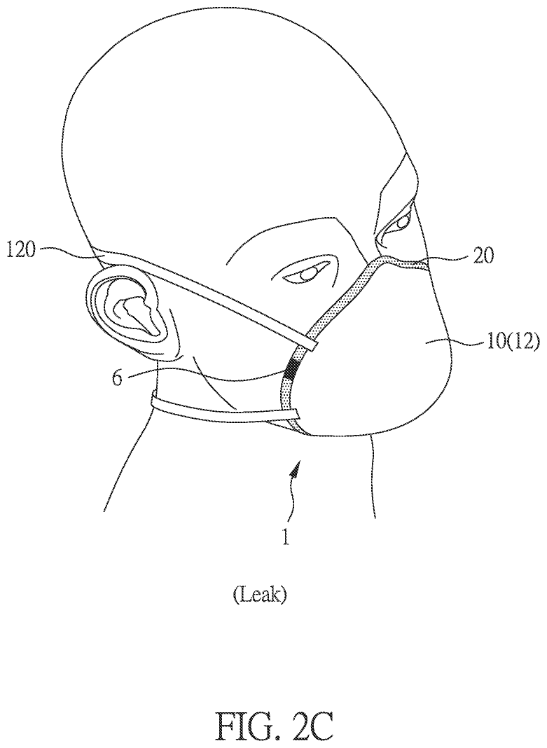

FIG. 2A shows a schematic diagram of the multilayer structure in the apparatus 1 with multipurpose pressure sensitive materials according to the second embodiment of the present invention.

FIGS. 2B-2C show schematic views of the apparatus 1 with multipurpose pressure sensitive materials according to the second embodiment of the present invention.

First, FIG. 2A schematically shows the multilayer structure in the apparatus 1 with multipurpose pressure sensitive materials according to the second embodiment of the present invention. In FIG. 2A, there is an inner layer 121, a pressure sensitive material 20, a filter 122, and an outer layer 123 from the left side (i.e., the side close to the face) to the right side (i.e., the side can be seen from the outside), respectively. It should be noted that, in the present embodiment, the pressure sensitive material 20 is merely located at the outer rim of the N95 face mask 12, so it is less likely to increase the pressure drop in the N95 face mask 12 and will not make the N95 face mask user harder to breath.

In the apparatus 1 with multipurpose pressure sensitive materials of the present invention, the polymer matrix composite of the pressure sensitive material 20 may contain nanoparticles.

When the N95 face mask 12 is used properly, the color of the pressure sensitive material 20 should change to a certain color (gray, for example), which indicates pressure added on the pressure sensitive material 20 is the same everywhere. This is referred as a non-leak case, as shown in FIG. 2B. The user can confirm that the mask 12 has no leak after the user sees the color of the pressure sensitive material 20 has been changed everywhere.

However, when the pressure added on the pressure sensitive material 20 of the N95 face mask 12 is insufficient, this indicates that there might be a leak. The pressure sensitive material 20 cannot change the color (remain black, for example) at the leak location 6, so that the user can identify the leak location, as shown in FIG. 2C.

### Third Embodiment

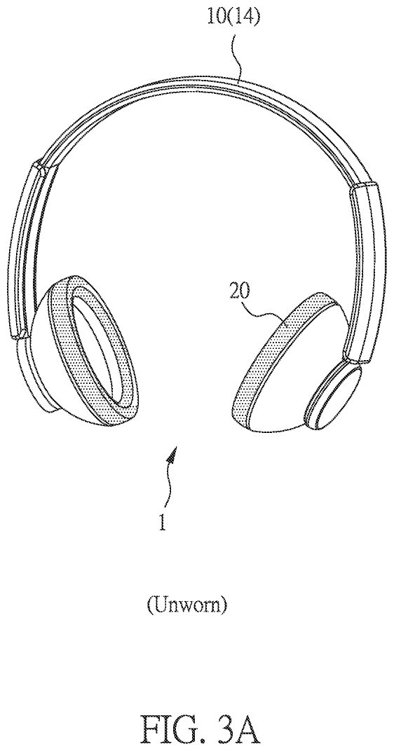

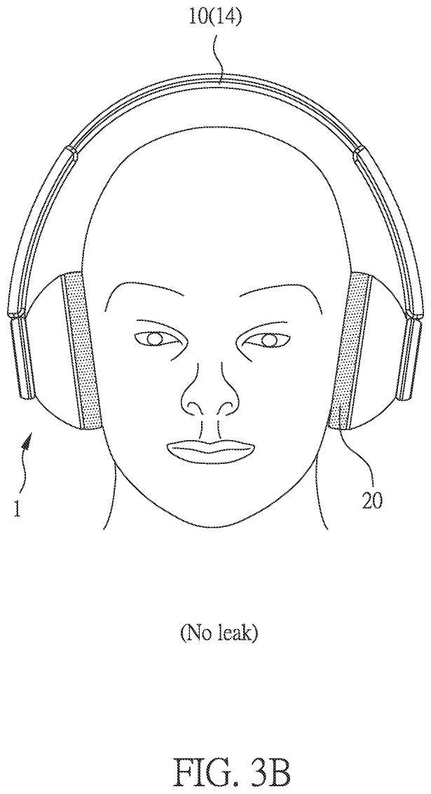

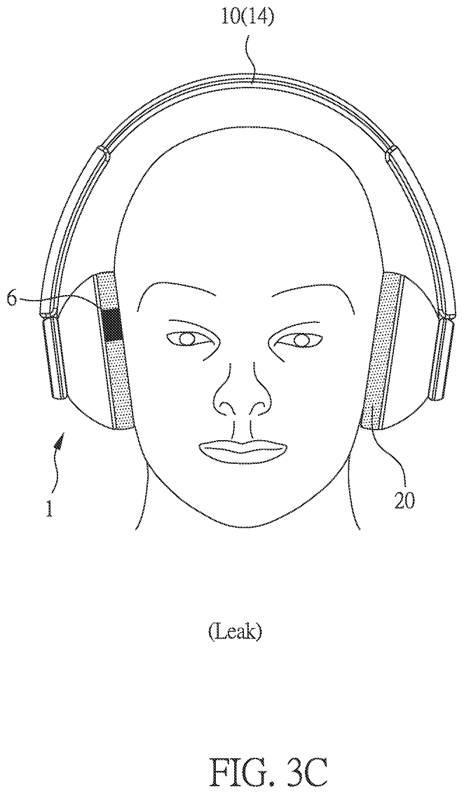

FIGS. 3A-3C show schematic views of the apparatus 1 with multipurpose pressure sensitive materials according to the third embodiment of the present invention;

With reference to FIG. 3A, in the third embodiment, the apparatus 1 with multipurpose pressure sensitive materials includes an outer part 10 and a pressure sensitive material 20. In particular, in the third embodiment, the outer part 10 is earmuffs 14.

In the third embodiment, the pressure sensitive material 20 is within the earmuffs 14, particularly on the inner layer of the earmuffs 14.

In the application, when the earmuffs 14 are properly used, the color of the pressure sensitive material 20 should change to a certain color, which indicates that the pressure added on the pressure sensitive material 20 are the same everywhere, as shown in FIG. 3B. The user can confirm that the earmuffs 14 have no leak after the user sees the color of the pressure sensitive material 20 has been changed everywhere.

However, when the pressure applied to the circumference of the ear is insufficient indicates that a leak occurs. At the moment, the color of the pressure sensitive material is not changed at the leak location 6, so the user can understand there is a leak taking place, as shown in FIG. 3C. Then, the user can adjust the earmuffs 14 to fix the leak problem and help protect the hearing.

### The Fourth Embodiment

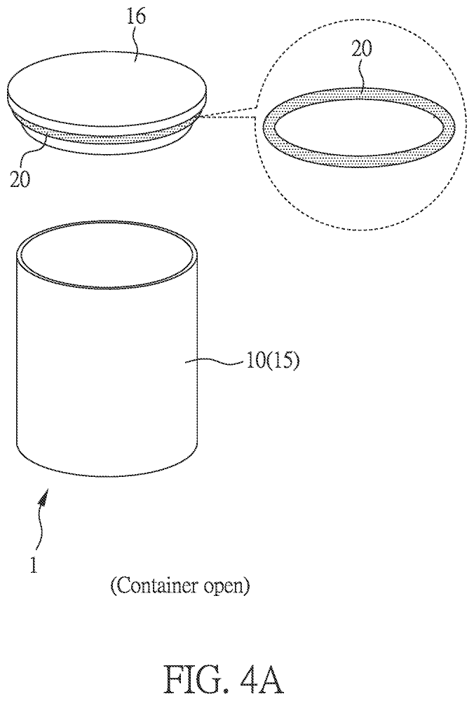

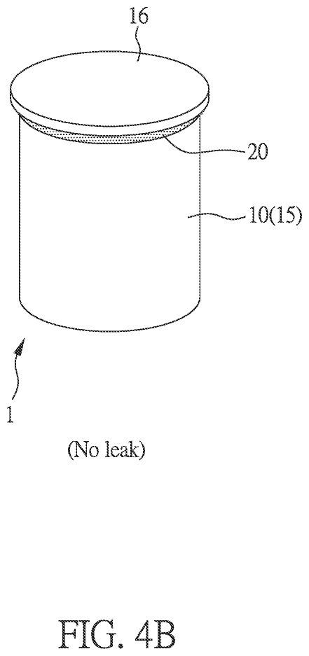

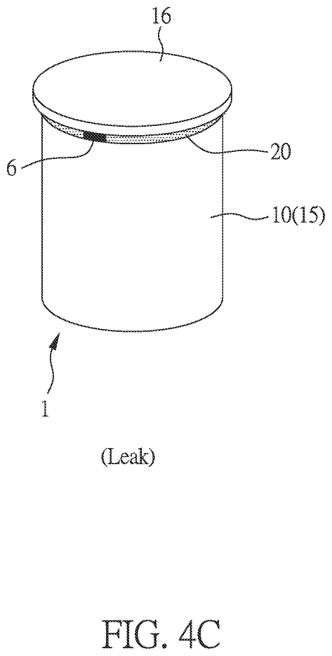

FIGS. 4A-4C show schematic views of the apparatus 1 with multipurpose pressure sensitive materials according to the fourth embodiment of the present invention.

With reference to FIG. 4A, in the fourth embodiment, the apparatus 1 with multipurpose pressure sensitive materials includes an outer part 10 and a pressure sensitive material 20. In the fourth embodiment, the outer part is a container 15.

In general, the pressure sensitive material 20 is located in the lid 16. The fourth embodiment also adopts such arrangement, as shown in FIG. 4A and FIG. 4B, because a leak is likely to occur at the engagement between the lid 16 and the bottle mouth, but other arrangements are also possible.

In the application, when the pressure that the lid 16 applies to the bottle mouth is insufficient, the color of the pressure sensitive material 20 would not change to a certain color, so the user can identify the leak location according to the location where the color is not changed, as shown in FIG. 4C. Then, the user can adjust the lid to fix the leak problem. If the leak cannot be fixed completely, the user can replace the lid or the container with a new one.

In other embodiments (not illustrated), the outer part 10 can be a crown, a bridge or a partial denture, wherein the pressure sensitive material 20 is a pressure indicating paste, coated on the inner side of the crown, the bridge or the partial. When the pressure sensitive material 20 is applied to the above-mentioned crown, bridge or partial denture, it can help the dentist to determine whether the fit and pressure between the crown, the bridge or the denture and a patient is good or not.

### Fifth Embodiment

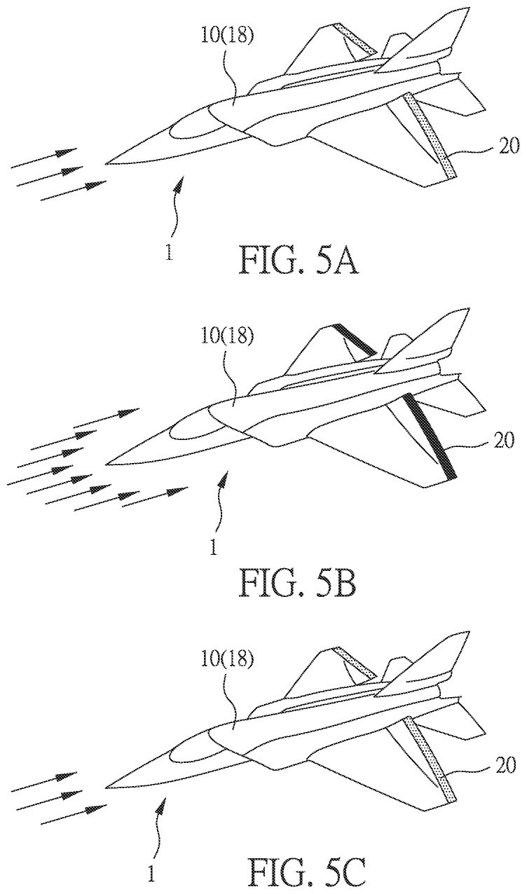

FIGS. 5A-5C show schematic views of the apparatus 1 with multipurpose pressure sensitive materials according to the fifth embodiment of the present invention.

In the fifth embodiment, the pressure sensitive material 20 is configured to change color with the external environment, such as the strength of the wind (or generally, fluid). In the present embodiment, the pressure sensitive material 20 is made into a pressure sensitive paint, painted on the wing of an airplane 18. In a wind tunnel test, when the wind is weak, the pressure applied to the airplane 18 is small, so the color of the pressure sensitive material 20 is light (i.e., the color change is less in the pressure sensitive paint), as shown in FIG. 5A and FIG. 5C. When wind is strong, the pressure applied to the airplane 18 is large, so the color of the pressure sensitive material 20 is dark (i.e., the color change is more in the pressure sensitive paint). The FIGS. 5A-5C schematically show the case of color change of the pressure sensitive material 20 under a process from strong wind to weak wind, then from weak wind to strong wind when the air plane 18 undergoes a wind tunnel evaluation. We can observe the pressure exerted on the airplane through taking pictures of the color change on the airplane. Similarly, the color change may be realized by full color or grayscale to show the leak level.

Thus, the pressure sensitive material 20 is allowed to be made into a pressure sensitive paint to apply in an aerodynamics field, such as using wind tunnel to evaluate air planes and weapons.

The pressure sensitive material can be also configured to change color according to an outer force, and configured such that the color recovers (i.e., returns to the original color) after the force at a distance disappears.

Taken together, according to the present invention, the user may realize a variety of applications by using the pressure sensitive material. Most importantly, the pressure sensitive material can be used repeatedly and thus economically feasible. A waste can be avoided as well.

Although the present invention has been explained in relation to its preferred embodiment, it is to be understood that many other possible modifications and variations can be made without departing from the spirit and scope of the invention as hereinafter claimed.

What is claimed is:

1. An apparatus with multipurpose pressure sensitive materials, comprising an outer part and a pressure sensitive material, the sensitive material being configured to change colors according to contact state between the outer part with an object and/or according to the outer part itself.

2. The apparatus with multipurpose pressure sensitive materials in claim 1, wherein the pressure sensitive material is a polymer matrix composite or other material, the pressure sensitive material can change colors with different added pressure.

3. The apparatus with multipurpose pressure sensitive materials in claim 2, wherein the color change of the pressure sensitive material is a reversible reaction.

4. The apparatus with multipurpose pressure sensitive materials in claim 3, wherein the pressure sensitive material is configured to indicate if a leak occurs through the color change according the contact state and/or the outer part itself.

5. The apparatus with multipurpose pressure sensitive materials in claim 1, wherein the outer part is a loose-fitting face mask, the loose-fitting face mask comprising a cloth face mask, a dust face mask, or a surgical mask.

6. The apparatus with multipurpose pressure sensitive materials in claim 1, wherein the outer part is a tight-fitting mask, the tight-fitting face mask comprising a N95, N99, N100, P95, P99, P100, R95, R99, R100 respirator, an Air-purifying Respirator, a Powered Air-Purifying Respirator (PAPR), a Supplied-Air Respirator (SR) or a Self-Contained Breathing Apparatus (SCBA).

7. The apparatus with multipurpose pressure sensitive materials in claim 1, wherein the pressure sensitive material is a polymer matrix composite, the polymer matrix composite contains nanoparticles.

8. The apparatus with multipurpose pressure sensitive materials in claim 5, wherein the loose-fitting face mask has an inner side and an outer side, the inner side is suitable for contacting a user's face, the outer side is opposite to the inner side, and wherein the pressure sensitive material is disposed on the inner side of the loose-fitting face mask.

9. The apparatus with multipurpose pressure sensitive materials in claim 6, wherein the tight-fitting face mask has an inner side and an outer side, the inner side is suitable for contacting a user's face, the outer side is opposite to the inner side, and wherein the pressure sensitive material is disposed on the inner side of the tight-fitting face mask.

10. The apparatus with multipurpose pressure sensitive materials in claim 1, wherein the outer part is earmuffs.

11. The apparatus with multipurpose pressure sensitive materials in claim 10, wherein the outer part is attached to an inner side of the earmuffs to contact a user's head.

12. The apparatus with multipurpose pressure sensitive materials in claim 1, wherein the outer part is a container.

13. The apparatus with multipurpose pressure sensitive materials in claim 12, wherein the pressure sensitive material is attached to a battle mouth of the container or an inner side of a lid thereof.

14. The apparatus with multipurpose pressure sensitive materials in claim 1, wherein the outer part is a crown, a bridge or a partial denture, and wherein the pressure sensitive material is a pressure indicating paste, coated on an inner side of the crown, the bridge or the partial denture.

15. The apparatus with multipurpose pressure sensitive materials in claim 1, wherein the pressure sensitive material is further configured to change color with an outer force, and configured to change back to it's original color when the outer force disappears.

16. The apparatus with multipurpose pressure sensitive materials in claim 1, wherein the pressure sensitive material is further configured to change color with an adjustable time under pressure, and the color change due to pressure can be quick or slow.

17. The apparatus with multipurpose pressure sensitive materials in claim 1, wherein the pressure sensitive material is made into a pressure sensitive paint that can be used in an aerodynamic field.

18. A method of leak identification, the method being executed by an apparatus with multipurpose pressure sensitive materials comprising an outer part and a pressure sensitive material, the sensitive material being configured to come to change according to contact state between the outer part with an object and/or according to the outer part itself, the method comprising:
step S1: attaching the pressure sensitive material to the outer part;
step S2: using the outer part to contact the object;
step S3: observing if a color change of the pressure sensitive material occurs; and
step S4: determining a leak location according to a location of the color change.

19. The method of leak identification in claim 18, wherein
determining a leak location according to a location of the color change is performed by scanning the object through an image detecting device or by simply using eyes.

20. The method of leak identification in claim 18, wherein the outer part is a face mask, an earmuff, a container.
